(19) United States
(12) Patent Application Publication
(10) Pub. No.: US 2008/0225000 A1
(43) Pub. Date: Sep. 18, 2008

(54) Cancellation of Environmental Motion In Handheld Devices

(76) Inventors: Thomas Alexander Bellwood, Austin, TX (US); Gabriel A. Cohen, San Mateo, CA (US); Ronald Eugene Craig, Pittsboro, NC (US); Travis M. Grigsby, Austin, TX (US); Gerald Laverte Mitchell, Raleigh, NC (US)

Correspondence Address: IBM CORP. (WSM);c/o WINSTEAD SECHREST & MINICK P.C., P.O. BOX 50784, DALLAS, TX, 75201, US

(21) Appl. No.: 11/687,405

(22) Filed: Mar. 16, 2007

(51) Int. Cl. G06F 3/033

(52) U.S. Cl. 345/158

(57) ABSTRACT

A method, system and computer program product for compensating the environmental motion in handheld devices. A sensor unit is affixed to an object in the environment to detect and measure environmental motion. Upon measuring any detected environmental motion, the sensor unit transmits a value corresponding to the measured environmental motion to one or more handheld devices. Alternatively, the sensor unit may transmit the value corresponding to the measured environmental motion to a unit configured to retransmit the value to one or more handheld devices. Upon receiving the value corresponding to the measured environmental motion, the handheld device cancels this environmental motion from the motion it measured thereby taking into consideration only the motion inputted by the user of the handheld device.

### TECHNICAL FIELD

The present invention relates to the field of motion sensing devices, and more particularly to compensating for environmental motion in handheld devices that detect motion as input from a user.

### BACKGROUND INFORMATION

Motion sensing is being incorporated in many devices, such as gaming devices. For example, Wii™, which is the fifth video game console released by Nintendo™, includes a wireless controller, the Wii™ remote, which can be used as a handheld pointing device and can detect motion and rotation in three dimensions. This design allows users to control a video game using physical gestures as well as traditional button presses. That is, by the user moving the Wii™ remote, the movement is translated into actions or prompts a response on the screen displaying the game.

Motion sensing is also being incorporated into cell phones so that users can play games through motions of the cell phone. For example, the movement of the phone through the air may translate into actions of a character in a game. The screen of the cell phone may show a game scenario from the character's point of view, and as the player turns around with the phone, so does the character in the game. In another example, the cell phone may act as a steering wheel in a racing game. As the user of the cell phone rotates the phone, the rotational movement corresponds to the movement of the car in the racing game.

Further, the use of the motion sensing technology in cell phones is not limited to playing games. For example, users may be able to make calls by drawing the numbers in the air or they can end a call by shaking the phone twice.

However, the motion sensing technology embedded in cell phones, game controllers and like devices may incorrectly detect a motion that was not manifested by the user. For example, suppose a child is playing with a motion sensitive gaming mobile phone in the car. As the car shifts right or left, comes to a sudden stop, travels up or down a hill, etc., the motion sensing technology may incorrectly attribute such motions as emanating from the user. Motions that are incorrectly attributed as emanating from the user but are in effect a result of the environment (e.g., movement of an automobile, movement of an airplane, movement of a bus) are referred to herein as “environmental motion.”

By not taking into consideration the environmental motion, an improper action (e.g., incorrect movement of a character in a game, improper number to call) may occur from the handheld devices incorporating motion sensing technology.

Therefore, there is a need in the art for a handheld device incorporating motion sensing technology to compensate for environmental motion.

### SUMMARY

The problems outlined above may at least in part be solved in some embodiments by having a sensor unit configured to detect and measure the environmental motion. The sensor unit may then transmit, either wirelessly or via wire, a value corresponding to the measured environmental motion to one or more handheld devices. Alternatively, the sensor unit may transmit the value corresponding to the measured environmental motion to a unit configured to retransmit the value to one or more handheld devices. Upon receiving the value corresponding to the measured environmental motion, the handheld device cancels this environmental motion from the motion it measured thereby taking into consideration only the motion inputted by the user of the handheld device.

In one embodiment of the present invention, a method for compensating for environmental motion in handheld devices comprises the step of affixing a sensor unit to an object in an environment to detect environmental motion. The method further comprises detecting and measuring a motion in the environment. The method further comprises detecting and measuring a motion of a handheld device. The method further comprises receiving a value corresponding to the motion measured in the environment. The method further comprises computing a motion of the handheld device by canceling the motion measured in the environment from the motion measured of the handheld device.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of various handheld devices;

FIG. 2 illustrates a hardware configuration of a handheld device in accordance with an embodiment of the present invention;

FIGS. 3A-B illustrate a sensor unit being affixed to a handheld device during power charging mode and being affixed to an object in the environment to detect the environmental motion in accordance with an embodiment of the present invention;

FIG. 4 illustrates a hardware configuration of the sensor unit in accordance with an embodiment of the present invention; and

FIG. 5 is a flowchart of a method for compensating the environmental motion from the motion measured by the handheld device in accordance with an embodiment of the present invention.

### DETAILED DESCRIPTION

The present invention comprises a method, system and computer program product for compensation for environmental motion in handheld devices. In one embodiment of the present invention, a sensor unit is affixed to an object in the environment to detect and measure environmental motion. Upon measuring any detected environmental motion, the sensor unit transmits a value corresponding to the measured environmental motion to one or more handheld devices. Alternatively, the sensor unit may transmit the value corresponding to the measured environmental motion to a unit configured to retransmit the value to one or more handheld devices. Upon receiving the value corresponding to the measured environmental motion, the handheld device cancels this environmental motion from the motion it measured thereby taking into consideration only the motion inputted by the user of the handheld device.

While the following discusses the use of a single sensor unit configured to detect and measure an amount of motion in the environment, the principles of the present invention may be applied to the use of multiple sensor units to detect and measure an amount of motion in the environment. A person of ordinary skill in the art would be capable of applying the principles of the present invention to the use of multiple sensor units to detect and measure an amount of motion in the environment. Embodiments covering the use of multiple sensor units to detect and measure an amount of motion in the environment fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

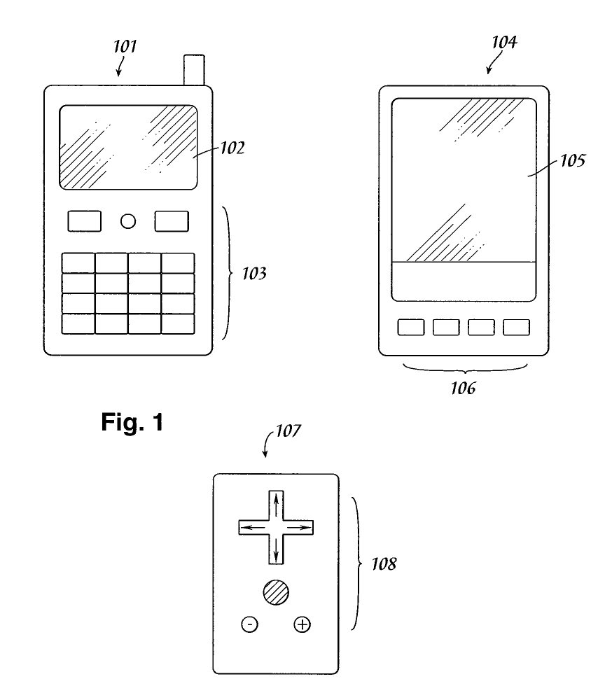

### FIG. 1—Handheld Devices

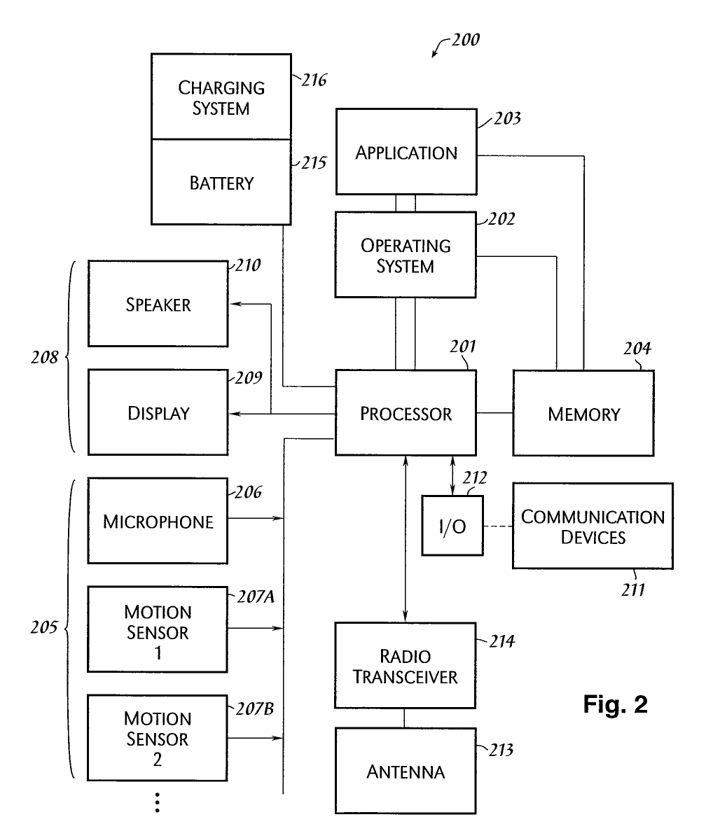

FIG. 1 illustrates several different types of handheld electronic devices with the capability of detecting motion as input from a user in accordance with an embodiment of the present invention. For example, referring to FIG. 1, a mobile telephone 101 may include motion sensing technology used to detect the movement of mobile telephone 101. Mobile telephone 101 may allow a user to connect to other telephones using a cellular network. Mobile telephone 101 typically includes a display 102 such as a character or graphical display, and input devices 103 such as a number pad for making numeric entries and in some cases a navigation pad fused or traversing through display 102. A detailed description of the internal components of mobile telephone 101, including its motion sensing capability, is provided below in connection with FIG. 2.

In another example, a personal digital assistant (PDA) 104, which may refer to a mobile handheld device that provides computing and information storage and retrieval capabilities for personal and/or business use, may also include the capability of detecting motion as input from a user. PDA 104 typically includes a display 105 such as a graphical display, and input devices 106 such as a stylus based resistive touch screen and buttons. A detailed description of the internal components of PDA 104, including its motion sensing capability, is provided below in connection with FIG. 2.

In another example, a wireless game controller 107 (e.g., Wii™ remote) may include the capability of detecting motion as input from a user. Controller 107 typically includes an input device 108, such as buttons, track balls, etc. A detailed description of the internal components of game controller 107, including its motion sensing capability, is provided below in connection with FIG. 2.

Handheld devices of the present invention are not to be limited in scope to the examples discussed above. “Handheld devices,” referred to herein, include any device with the capability of receiving motion from a user as input.

### FIG. 2—Internal Components of a Handheld Device

FIG. 2 illustrates the internal components of a typical handheld device 200 in accordance with an embodiment of the present invention. Handheld device 200 may refer to any device with the capability of receiving motion from a user as input where mobile telephone 101 (FIG. 1), PDA 104 (FIG. 1) and wireless game controller 107 (FIG. 1) are examples of such a handheld device.

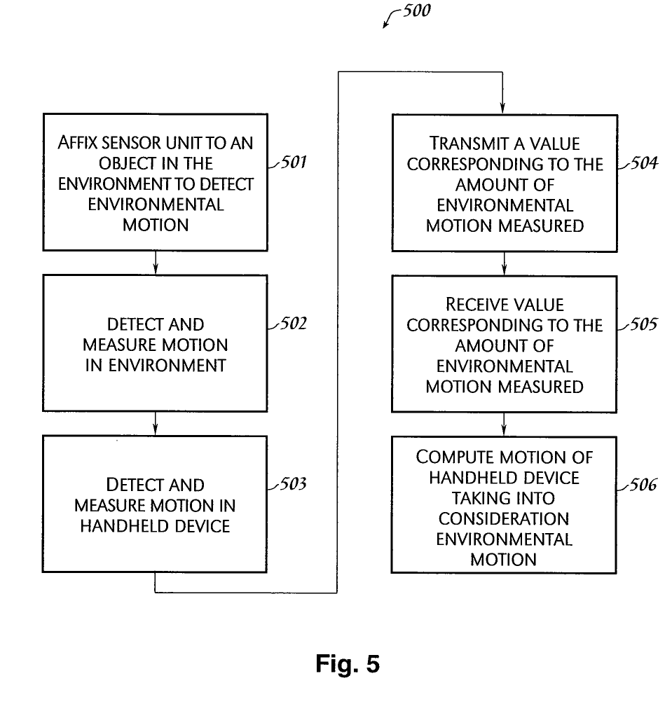

Referring to FIG. 2, handheld device 200 may include a processor 201 configured to execute instructions and to carry out operations associated with handheld device 200. An operating system 202 may run on processor 201 and provide control and coordinate the functions of the various components of FIG. 2. An application 203 in accordance with the principles of the present invention may run in conjunction with operating system 202 and provide calls to operating system 202 where the calls implement the various functions or services to be performed by application 203. Application 203 may include, for example, an application for compensating for environmental motion in handheld devices 200 as discussed below in association with FIG. 5.

Handheld device 200 may further include a memory 204 coupled to processor 201. Software components, including operating system 202 and application 203, may be loaded into memory 204 which may be handheld device's 200 main memory for execution. Processor 201, using instructions retrieved from memory, may control the reception and manipulation of input and output data between components of the handheld device 200. Processor 201 can be implemented on a single chip, multiple chips or multiple electrical components. For example, various architectures can be used for processor 201, including dedicated or embedded processor, single purpose processor, controller, application-specific integrated circuit (ASIC), etc. By way of example, processor 201 may include microprocessors, digital signal processors, A/D converters, D/A converters, compression, decompression, etc.

In most cases, processor 201 together with operating system 202 operates to execute computer code and produce and use data. Operating system 202 may correspond to well known operating systems such as OS/2, DOS, Unix, Linux, and Palm OS, or alternatively to special purpose operating system, such as those used for limited purpose appliance-type devices.

As discussed above, memory 204 generally provides a place to store computer code and data that are used by handheld device 200. By way of example, memory 204 may include read-only memory (ROM), random-access memory (RAM), hard disk drive (e.g., a micro drive), flash memory, etc. In conjunction with memory 204, handheld device 200 may include a removable storage device (not shown) such as card slots (not shown) for receiving mediums such as memory cards (or memory sticks).

Handheld device 200 may also include various input devices 205 that are operatively coupled to processor 201. Input devices 205 are configured to transfer data from the outside world into hand-held device 200. Input devices 205 may include a microphone 206 and one or more motion sensors 207A-B. Motion sensors 207A-B may collectively or individually be referred to as motion sensors 207 or motion sensor 207, respectively. While FIG. 2 illustrates only two motion sensors 207, handheld device 200 may include any number of motion sensors 207. Examples of motion sensors 207 include: a tilt sensor configured to detect an angle of tilt; an accelerometer configured to measure a vector of acceleration; and an optical mouse. “Motion sensors” of the present invention are not to be limited in scope to these examples. “Motion sensors,” as used herein, may refer to any sensor configured to detect any type of motion.

Handheld device 200 may include various output devices 208 that are operatively coupled to processor 201. Output devices 208 are configured to transfer data from hand-held device 200 to the outside world. Output devices 208 may include a display 209, such as a liquid crystal display a speaker 210, and the like.

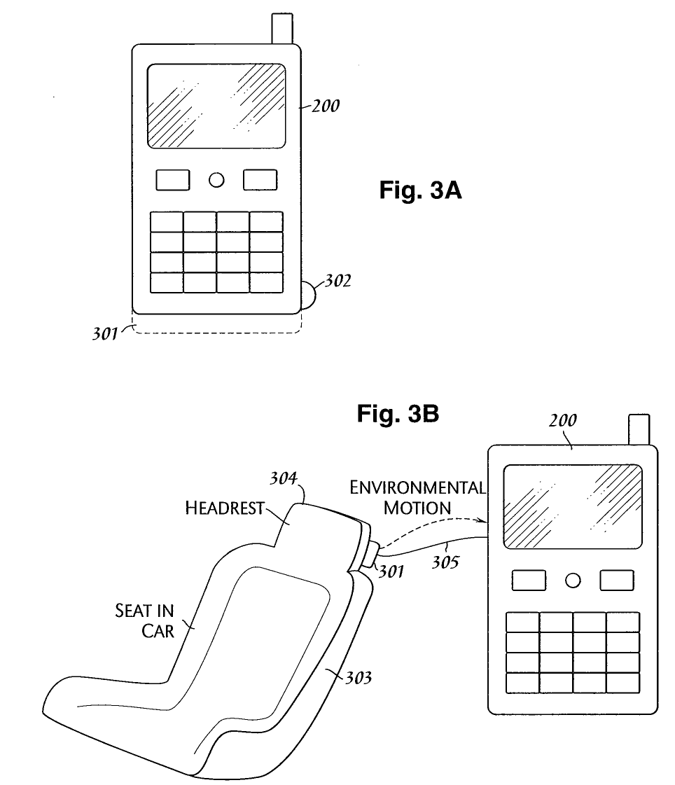

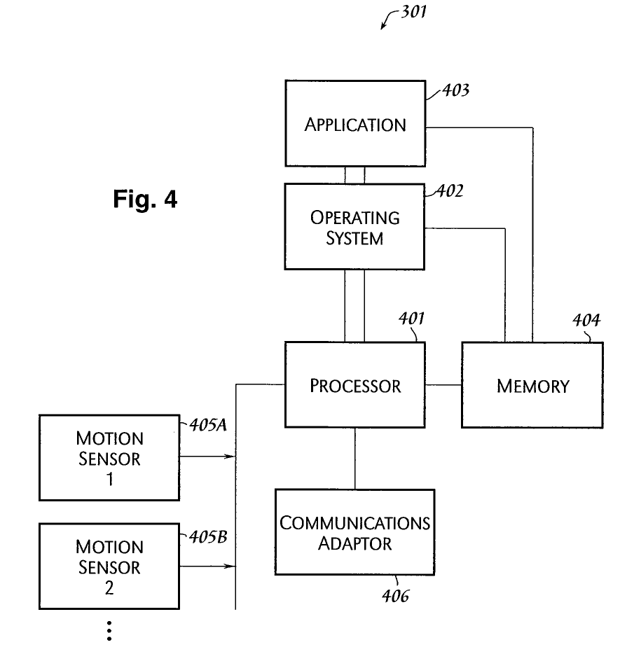

Handheld device 200 may also include various communication devices 211, such as a sensor unit as discussed further below in connection with FIGS. 3-4. Communication devices 211 are operatively coupled to processor 201. Communication devices 211 may be coupled to processor 201, via a wire or wirelessly, via Input/Output (I/O) ports 212, such as infrared and universal serial bus ports. Data from communication devices 211 in the form of radio waves may also be received by processor 201 via antenna 213 coupled to radio transceiver 214. Radio transceiver 214 may be configured to both transmit and receive data signals via antenna 213.

Handheld device 200 may further include a battery 215 and a charging system 216. Battery 215 may be charged through a transformer and power cord or through a host device or through a docking station. In the cases of the docking station, the charging may be transmitted through electrical ports or possibly through an inductance charging means that does not require a physical electrical connection to be made. Charging system 216 may be used to not only charge battery 215 of handheld device 200 but to charge a battery in communication devices 211, such as a sensor unit as discussed further below in connection with FIGS. 3A-B and FIG. 4. The sensor unit may be affixed to handheld device 200 via any means, such as via magnetism, a clip or a strap. Further, the sensor unit may be connected to handheld device 200 via I/O port 212 thereby allowing the battery of the sensor unit to be charged by charging system 216 of handheld unit 200. Further, the sensor unit may be embedded in handheld device 200 such as via a slot (not shown) thereby allowing the battery of the sensor unit to be charged by charging system 216 of handheld unit 200.

The various aspects, features, embodiments or implementations of the invention described above can be used alone or in various combinations. The methods of handheld device 200 can be implemented by software, hardware or a combination of hardware and software. The invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

As discussed above, handheld device 200 may be in communication with a sensor unit. The sensor unit is configured to detect and measure an amount of motion in the environment as discussed further below in connection with FIGS. 3A-B and FIG. 4. The sensor unit may be configured to be affixed or embedded within handheld device 200 as illustrated in FIG. 3A and may be configured to be detached from handheld device 200 and affixed to an object (e.g., head rest of a seat in an automobile) in an environment as illustrated in FIG. 3B. A more detail description of FIGS. 3A-B is provided below.

### FIGS. 3A-B—Sensor Unit Affixed to Handheld Device and Environment

FIG. 3A illustrates an embodiment of the present invention of a sensor unit 301 being affixed to handheld device 200 (FIG. 2), such as via a strap 302. Sensor unit 301 may be affixed to handheld device 200 in other manners as well, such as via magnetism or a clip. Sensor unit 301 may be affixed to handheld device 200 by any means (in addition to the ones mentioned herein). Further, sensor unit 301 may be affixed to handheld device 200 in such a manner as to allow sensor unit 301 to be connected to handheld device 200 via I/O port 212 (FIG. 2) thereby allowing the battery (not shown) of sensor unit 301 to be charged via charging system 216 (FIG. 2) of handheld device 200. Further, sensor unit 301 may be embedded (not shown) in handheld device 200 via a slot (not shown) thereby allowing the battery (not shown) of sensor unit 301 to be charged via charging system 216 (FIG. 2) of handheld device 200.

As mentioned above, sensor unit 301 is configured to detect and measure an amount of motion in the environment. Sensor unit 301 detects and measures the amount of motion in the environment by being detached from handheld unit 200 and attached to an object of the environment as illustrated in FIG. 3B. For example, sensor unit 301 may be attached to the back of a head rest in a seat in a car (object of the environment) thereby monitoring and detecting the movement of the automobile (environmental motion). In this manner, as will be discussed in further detail below, the movement of the automobile (environmental motion) will be taken into consideration by a handheld device used by the user in the automobile so that the handheld device will only attribute motions by the user as inputs to the handheld device. While the following discusses canceling environmental motion in connection with the movement of an automobile, the principles of the present invention may be applied to the cancellation of the environmental motion in any environment where environmental motion may be inputted to a handheld device incorporating motion sensing technology. A person of ordinary skill in the art would be capable of applying the principles of the present invention to such other embodiments.

Referring to FIG. 3B, sensor unit 301 is affixed to the back of a head rest 304 of a seat 303 in an automobile. Sensor unit 301 may be affixed to the back of head rest 304 by any means, such as magnetism, a strap, a clip, etc. Since sensor unit 301 is affixed to an object of the environment, sensor unit 301 can detect and measure the amount of environmental motion and communicate a value corresponding to the environmental motion to handheld device 200 via a wire 305 or wirelessly. Upon receipt of the measured environmental motion from sensor unit 301, handheld unit 200 may cancel this measured environmental motion from the motion it detected thereby only considering the motion inputted by the user of handheld unit 200 as discussed further below in connection with FIG. 5.

In an alternative embodiment, sensor unit 301 may be attached to an object in the environment where sensor unit 301 transmits (via wire or wirelessly) the measured environmental motion to multiple handheld units 200.

In another alternative embodiment, sensor unit 301 may be wedged in a location (e.g., a nook on an airplane) where sensor unit 301 transmits the measured environmental motion to one or more handheld units 200 (e.g., multiple airplane passengers with handheld units). It is noted for clarity that the use of the phrase “affixing a sensor unit to an object in an environment” covers such embodiments where sensor unit 301 may tangentially be touching the object (e.g., airplane) of the environment.

In another alternative embodiment, sensor unit 301 may be attached to an object in the environment where sensor unit 301 transmits (via wire or wirelessly) the measured environmental motion to a unit other than handheld unit 200. For example, sensor unit 301 may broadcast its measured environmental motion to a server which will then rebroadcast the measured environmental motion to one or more handheld units 200.

The hardware configuration of sensor unit 301 illustrating the capability of sensor unit 301 detecting and measuring the amount of environmental motion is provided below in connection with FIG. 4.

### FIG. 4—Hardware Configuration of Sensor Unit

FIG. 4 illustrates a hardware configuration of sensor unit 301 (FIG. 4) which is representative of a hardware environment for practicing the present invention. Sensor unit 301 may have a processor 401 configured to execute instructions and to carry out operations associated with sensor unit 301. An operating system 402 may run on processor 401 and provide control and coordinate the functions of the various components of FIG. 4. An application 403 in accordance with the principles of the present invention may run in conjunction with operating system 402 and provide calls to operating system 402 where the calls implement the various functions or services to be performed by application 403. Application 403 may include, for example, an application for detecting and measuring the environmental motion as discussed below in association with FIG. 5.

Sensor unit 301 may further include a memory 404 coupled to processor 401. Software components, including operating system 402 and application 403, may be loaded into memory 404 which may be sensor unit's 301 main memory for execution. Processor 401, using instructions retrieved from memory, may control the reception and manipulation of input and output data between components of sensor unit 301. Processor 401 can be implemented on a single chip, multiple chips or multiple electrical components. For example, various architectures can be used for processor 401, including dedicated or embedded processor, single purpose processor, controller, application-specific integrated circuit (ASIC), etc. By way of example, processor 401 may include microprocessors, digital signal processors, A/D converters, D/A converters, compression, decompression, etc.

In most cases, processor 401 together with operating system 402 operates to execute computer code and produce and use data. Operating system 402 may correspond to well known operating systems such as OS/2, DOS, Unix, Linux, and Palm OS, or alternatively to special purpose operating system, such as those used for limited purpose appliance-type devices.

As discussed above, memory 404 generally provides a place to store computer code and data that are used by sensor unit 301. By way of example, memory 404 may include read-only memory (ROM), random-access memory (RAM), hard disk drive (e.g., a micro drive), flash memory, etc. In conjunction with memory 404, sensor unit 301 may include a removable storage device (not shown) such as card slots (not shown) for receiving mediums such as memory cards (or memory sticks).

Sensor unit 301 may further include one or more motion sensors 405A-B coupled to processor 401. Motion sensors 405A-B may collectively or individually be referred to as motion sensors 405 or motion sensor 405, respectively. While FIG. 4 illustrates only two motion sensors 405, sensor unit 301 may include any number of motion sensors 405. Examples of motion sensors 405 include: a tilt sensor configured to detect an angle of tilt; an accelerometer configured to measure a vector of acceleration; and an optical mouse. “Motion sensors” of the present invention are not to be limited in scope to these examples. “Motion sensors,” as used herein, may refer to any sensor configured to detect any type of motion.

Sensor unit 301 may further include a communications adapter 406 coupled to processor 401. Communications adapter 406 enables sensor unit 301 to communicate with handheld units 200, computer systems and other such like devices via wirelessly or wire.

The various aspects, features, embodiments or implementations of the invention described above can be used alone or in various combinations. The methods of sensor unit 301 can be implemented by software, hardware or a combination of hardware and software. The invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

As stated above, motion sensing technology embedded in cell phones, game controllers and like devices may incorrectly detect a motion that was not manifested by the user. For example, suppose a child is playing with a motion sensitive gaming mobile phone in the car. As the car shifts right or left, comes to a sudden stop, travels up or down a hill, etc., the motion sensing technology may incorrectly attribute such motions as emanating from the user. Motions that are incorrectly attributed as emanating from the user but are in effect a result of the environment (e.g., movement of an automobile, movement of an airplane, movement of a bus) are referred to herein as “environmental motion.” By not taking into consideration the environmental motion, an improper action (e.g., incorrect movement of a character in a game, improper number to call) may occur from the handheld devices incorporating motion sensing technology. Therefore, there is a need in the art for a handheld device incorporating motion sensing technology to compensate for environmental motion. A description of a method for compensating the environmental motion in a handheld device thereby allowing the handheld device to correctly evaluate the motion from the user of the handheld device is described below in association with FIG. 5.

### FIG. 5—Method for Compensating Environmental Motion in Handheld Devices

FIG. 5 is a flowchart of a method 500 for compensating environmental motion in handheld devices 200 (FIG. 2) in accordance with an embodiment of the present invention.

Referring to FIG. 5, in conjunction with FIGS. 1-4, in step 501, sensor unit 301 is affixed to an object (e.g., back of head rest 304 in a car) in the environment to detect environmental motion (e.g., movement of an automobile). As discussed above, sensor unit 301 may be affixed to an object in the environment by any means, such as magnetism, a strap and a clip.

In step 502, sensor unit 301 detects and measures a motion in the environment. Sensor unit 301 may detect and measure a motion in the environment using one or more different motion sensors 405 (e.g., accelerometer, tilt sensor).

In step 503, handheld device 200 detects and measures a motion. The motion detected by handheld device 200 may be a combination of motions, such as a motion inputted by the user of handheld device 200 and the environmental motion. Handheld device 200 may detect and measure a motion using one or more different motion sensors 207 (e.g., accelerometer, tilt sensor).

In step 504, sensor unit 301 transmits to handheld unit 200 a value corresponding to the amount of environmental motion measured by sensor unit 301 in step 502. In one embodiment, sensor unit 301 transmits to handheld unit 200 wirelessly the value corresponding to the amount of environmental motion measured by sensor unit 301. In another embodiment, sensor unit 301 transmits to handheld unit 200 via wire the value corresponding to the amount of environmental motion measured by sensor unit 301. In an alternative embodiment, sensor unit 301 transmits the value corresponding to the amount of environmental motion measured to a unit separate from handheld device 200 (e.g., a server configured to rebroadcast the measured environmental motion to one or more handheld units 200). In an alternative embodiment, sensor unit 301 transmits the value corresponding to the amount of environmental motion measured to a plurality of handheld devices 200.

In step 505, handheld device 200 receives the value corresponding to the measured environmental motion from sensor unit 301.

In step 506, handheld device 200 computes the motion of handheld device 200 by canceling the motion detected in the environment (value received from sensor unit 301 in step 505) from the motion detected by handheld device 200 in step 503. By canceling the environmental motion, handheld device 200 is able to correctly quantify the amount of motion inputted by the user of handheld device 200.

It is further noted that method 500 may include other and/or additional steps that, for clarity, are not depicted. It is further noted that method 500 may be executed in a different order presented and that the order presented in the discussion of FIG. 5 is illustrative. It is further noted that certain steps in method 500 may be executed in a substantially simultaneous manner or may be omitted.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for compensating for environmental motion in handheld devices comprising the steps of:
detecting and measuring a motion in an environment using a sensor affixed to an object in said environment;
detecting and measuring a motion of a handheld device;
receiving a value corresponding to said motion measured in said environment; and
computing a motion of said handheld device by canceling said motion measured in said environment from said motion measured of said handheld device.

2. The method as recited in claim 1, wherein said value corresponding to said motion measured in said environment is received by said handheld device.

3. The method as recited in claim 1, wherein said value corresponding to said motion measured in said environment is received by a unit separate from said sensor unit and said handheld device.

4. The method as recited in claim 1, wherein said motion measured in said environment is transmitted wirelessly to one of said handheld device and a unit separate from said sensor unit and said handheld device.

5. The method as recited in claim 1, wherein said motion measured in said environment is transmitted wirelessly to a plurality of handheld devices.

6. The method as recited in claim 1, wherein said motion measured in said environment is transmitted via wire to one of said handheld device and a unit separate from said sensor unit and said handheld device.

7. The method as recited in claim 1, wherein said sensor unit is affixed to said object in said environment via one or more of the following: magnetism, a strap, a clip.

8. The method as recited in claim 1, wherein said sensor unit comprises one or more of the following: a tilt sensor to detect an angle of tilt and an accelerometer to measure a vector of acceleration.

9. The method as recited in claim 1, wherein said handheld device comprises one of the following: a cell phone, a personal digital assistant and a game controller.

10. The method as recited in claim 1, wherein said sensor unit is configured to be affixed to said handheld device.

11. The method as recited in claim 1, wherein said sensor unit is configured to be embedded within said handheld device.

12. A system, comprising:
a handheld device, wherein said handheld device comprises:
a first processor;
a display coupled to said first processor;
one or more motion sensors configured to measure a motion of said handheld device; and
a memory unit for storing a computer program for compensating for environmental motion in said handheld device, wherein said memory unit is coupled to said first processor, wherein said first processor, responsive to said computer program, comprises:
circuitry for receiving a value corresponding to motion measured in an environment; and
circuitry for computing a motion of said handheld device by canceling said motion measured in said environment from said motion measured of said handheld device.

13. The system as recited in claim 12 further comprises:
a sensor unit affixed to an object in said environment, wherein said sensor unit comprises:
one or more motion sensors for measuring said motion in said environment;
a second processor coupled to said one or more motion sensors of said sensor unit; and
a communications adapter coupled to said second processor, wherein said second processor is configured to transmit said value corresponding to said motion measured in said environment to said handheld device.

14. The system as recited in claim 13, wherein said second processor transmits said value corresponding to said motion measured in said environment to said handheld device wirelessly.

15. The system as recited in claim 13, wherein said second processor transmits said value corresponding to said motion measured in said environment to said handheld device via wire.

16. The system as recited in claim 13, wherein said sensor unit is affixed to said object in said environment via one or more of the following: magnetism, a strap, a clip.

17. The system as recited in claim 13, wherein said sensor unit is configured to be embedded within said handheld device.

18. A computer program product embodied in a computer readable medium for compensating for environmental motion in handheld devices comprising the programming steps of:
detecting and measuring a motion of a handheld device;
receiving a value corresponding to a motion measured in an environment from a sensor unit affixed to an object in said environment; and
computing a motion of said handheld device by canceling said motion measured in said environment from said motion measured of said handheld device.

19. The computer program product as recited in claim 18, wherein said sensor unit is affixed to said object in said environment via one or more of the following: magnetism, a strap, a clip.

20. The computer program product as recited in claim 18, wherein said handheld device comprises one of the following: a cell phone, a personal digital assistant and a game controller.
